(19) United States
(12) Patent Application Publication
(10) Pub. No.: US 2015/0046219 A1
(43) Pub. Date: Feb. 12, 2015

(54) AVATAR-BASED AUTOMATED LEAD SCORING SYSTEM

(71) Applicant: Mark J. Shavlik, White Bear Lake, MN (US)

(72) Inventor: Mark J. Shavlik, White Bear Lake, MN (US)

(21) Appl. No.: 13/962,729

(22) Filed: Aug. 8, 2013

(51) Int. Cl. G06Q 30/02

(52) U.S. Cl. CPC G06Q 30/0203
USPC 705/7.31

(57) ABSTRACT

An automated lead scoring system includes a web crawling process configured to collect data from one or more disparate, unaffiliated data sources to obtain information describing attributes of an avatar, the attributes including information descriptive of a prospective customer and actions taken by the prospective customer in response to exposure to a product or service. The system further includes a database communicatively connected to the computing system and configured to receive the information for storage in a database entry associated with the avatar. The system also includes a scoring component assigning a value in the database entry to each of an avatar, attributes of the avatar, and each data source from which the attributes are retrieved, as well as a prediction component configured to compare based on a correspondence between the database entry and known profiles of users of a product or service.

### BACKGROUND

Companies of all sizes must allocate a substantial amount of resources, such as time, money, and effort, to marketing efforts and to identifying potential customers (i.e., sales leads). Such efforts include costs for marketing campaigns, as well as costs and time required to contact potential customers, to learn the interests of those potential customers and to otherwise establish such relationships.

Software systems exist which are designed to better allow companies or individuals to manage sales leads. Such systems generally are designed to allow sales personnel to track contact information, sources of such leads, lead quality, and other information that enables those sales personnel to contact, develop, and qualify sales leads as sales opportunities.

However, existing marketing and sales lead development systems have a number of drawbacks. For example, existing marketing systems lack the ability to adequately identify those individuals who may be interested in a particular good/service, absent some manual input from sales personnel. In other words, sales personnel must typically seek potential sales targets and develop those targets based on some criteria (e.g., being a contact with purchasing authority at a company who may be a good fit for a product or service to be sold). These criteria can range from operating in a general market or technical field to being a current customer of a different product or version of a product. Additionally, existing marketing and sales lead development systems lack the ability to identify, without some level of human involvement, the particular marketing mechanisms that resulted in any sales leads.

Furthermore, existing sales lead management software systems are tailored to identifying and managing such sales leads, while lacking an ability to accurately provide a qualitative assessment of the sales lead apart from a qualitative assessment made at least in part by sales personnel. This results in sales personnel contacting leads that are “cold” leads based either on a lack of information, or based on potential manual mis-characterization of a lead. Accordingly, existing sales lead management software systems include inherent inefficiencies based on requiring user intervention to ensure accurate, up-to-date information about contacts maintained by those software systems.

### SUMMARY

In accordance with the following disclosure, the above and other issues are addressed by the following:

In a first aspect, an automated lead scoring system includes a web crawling process executing on a computing system, the web crawling process configured to collect data from one or more disparate, unaffiliated data sources to obtain information describing attributes of an avatar, the attributes including information descriptive of a prospective customer and actions taken by the prospective customer in response to exposure to a product or service. The system further includes a database communicatively connected to the computing system and configured to receive the information for storage in a database entry associated with the avatar. The system also includes a scoring component assigning a value in the database entry to each of an avatar, attributes of the avatar, and each data source from which the attributes are retrieved, as well as a prediction component configured to compare based on a correspondence between the database entry and known profiles of users of a product or service.

In a second aspect, a method of scoring sales leads in a computer-based system, is disclosed. The method includes periodically performing an automatic crawling process across one or more disparate, unaffiliated data sources to obtain information describing attributes of an avatar, the attributes including information descriptive of a prospective customer and actions taken by the prospective customer in response to exposure to a product or service. The method further includes storing values associated with the avatar, the attributes of the avatar, and the source from which information is received in a database record, as well as continuously tracking a score for the avatar based on aggregated values. The method also includes generating one or more predictions based on a correspondence between the database record and known users of a product or service.

In a third aspect, a computer-readable storage medium is disclosed that includes computer-executable instructions which, when executed, cause a computing system to perform a method of scoring sales leads in a computer-based system. The method includes periodically performing an automatic scraping process across one or more disparate, unaffiliated data sources to obtain information describing attributes of an avatar, the attributes including information descriptive of a prospective customer and actions taken by the prospective customer in response to exposure to a product or service. The method also includes storing values associated with the avatar, the attributes of the avatar, and the source from which information is received in a database record, as well as continuously tracking a score for the avatar based on aggregated values, the score based at least in part on elapsed time since actions reflected in the overall score have occurred. The method further includes generating one or more predictions based on a correspondence between the database record and known users of a product or service to estimate one or more actions likely taken by the avatar, and generating a suggestion of one or more actions to take relative to the avatar, the one or more actions including making an offer to the avatar. The method includes, based on a response to the offer, adjusting the score for the avatar.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an environment in which an avatar-based automated lead scoring system can be implemented, according to an example aspect of the present disclosure;

FIG. 2 illustrates an avatar-based automated lead scoring system, according to an example embodiment of the present disclosure;

FIG. 3 illustrates an avatar database useable in connection with the avatar-based automated lead scoring system of FIG. 2;

FIG. 4 illustrates an example electronic computing device with which aspects of the present disclosure can be implemented;

FIG. 5 illustrates a flowchart of a method of scoring sales leads in a computer-based system, according to an example embodiment;

FIG. 6 illustrates a flowchart of a method of scoring sales leads in a computer-based system, according to a second example embodiment; and

FIG. 7 illustrates a schematic user interface with which a salesperson can interact with an avatar-based automated lead scoring system, according to an example embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general, the present disclosure relates to an avatar-based automated lead scoring system, which allows for continuous, automated monitoring and updating of prospective sales leads. The systems and methods of the present disclosure include systems for prediction of behavior of sales leads based on comparison to known behaviors and known profiles, thereby allowing the system to suggest actions to take with respect to particular leads that have proved successful in the past. The system automation, as well as the learning aspects of the known profiles, allows the system to save substantial user time and cost, and improves over time as additional behaviors are learned. The system, generally described, includes a set of processes and related data that tracks a person, referred to herein as a prospective customer, through the marketing, sales, and finally the active customer process with the intent of actively predicting the next step taken by that person as it relates to making a purchase from a vendor.

In connection with the present disclosure, in some cases individuals who may become sales leads are referred to herein as “avatars”, which refers to the perceptible, public online manifestation of a person. As illustrated in the examples discussed herein, avatars can take a variety of forms, based on the types of information made available by the individual to the public. Avatars can be used, in the various embodiments discussed herein, to assess an individual's interest in a particular product or service, allowing companies and associated sales personnel to qualify those individuals as potential sales leads based on information made available by those individuals.

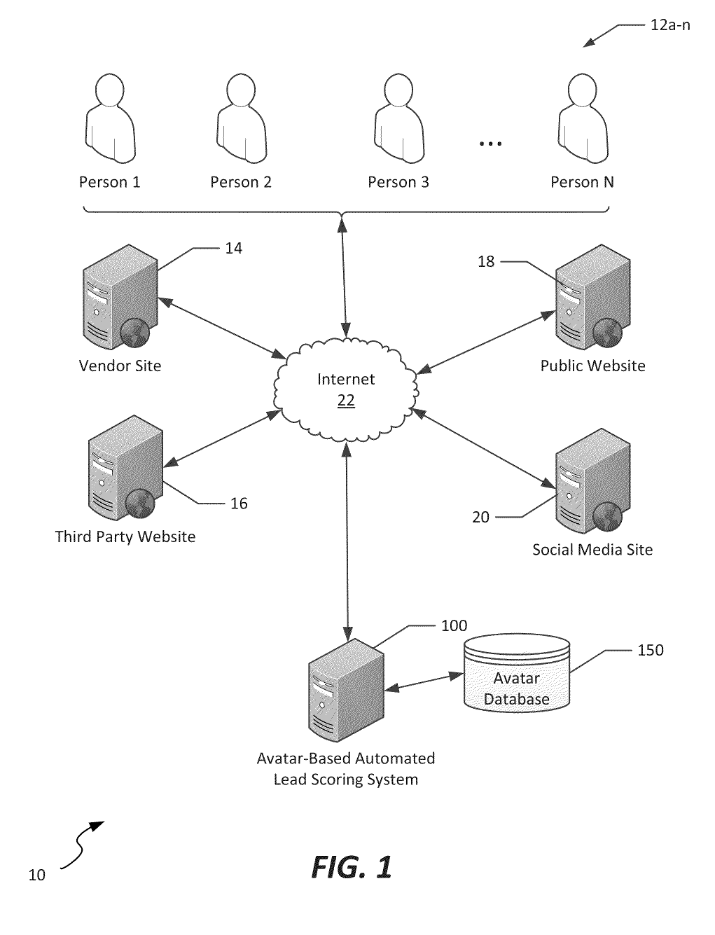

Referring now to FIG. 1, an example environment 10 is illustrated in which an avatar-based automated lead scoring system 100 can be implemented. In the embodiment shown, the avatar-based automated lead scoring system 100 is communicatively connected to a variety of people and entities. This includes a plurality of potential sales leads 12, shown as people 12a-n, as well as a plurality of websites 14-20. The websites can include, for example, a vendor site 14, a third party website 16, a public website 18, or a social media website 20. Of course, other types of websites are present as well, and interconnected to the avatar-based automated lead scoring system 100 via the Internet 22.

In the embodiment shown, the people 12a-n correspond to individuals who could be potential customers. These individuals are not known to a seller of a product or service, and as such are effectively anonymous to that seller. The people 12a-n can be, for example, individuals seeking to purchase a product or service, an individual performing his/her job functions at a company, or simply individuals browsing and interacting with resources available via the Internet. To that end, people 12a-n may interact with websites 14-20.

Vendor site 14 corresponds to a website owned or controlled by a vendor of a good or service. The website generally can be tracked by the vendor, and can include product or service information, as well as features allowing for interactivity with the people 12a-n. Third party website 16 can be, for example, a website of a competitor of the vendor or a vendor of a similar or related product or service, such that visits to the third party site, comments on the third party site, or other interactivity could indicate interest in a product or service provided by the vendor. Public website 18 can be, for example, a news website or other site at which user visits, comments, or other input can be tracked. Example websites could include product or service review websites, bulletin board websites, or other types of sites at which individual input is tracked and made publicly available for viewing/access. Social media website 20 can correspond to any social networking site or social interaction site at which user information can be made publicly available. Example social media sites can include, for example, Facebook, LinkedIn, Twitter, or other sites.

In general, avatar-based automated lead scoring system 100 is configured to crawl one or more of the various websites 14-20 to obtain content that may be of interest to a particular vendor or vendors. For example, avatar-based automated lead scoring system 100 can seek (1) instances where a particular person (e.g. any of people 12a-n) is associated with a reference to the vendor's product or service, such as by commenting on the product or service, or by visiting or commenting on the product or service at the vendor site 14 or in a review on public website 18, or viewing/editing/writing a comment regarding the product or service on social media website 20. Based on this gathered information, and as discussed further below, details regarding those people 12a-n can be aggregated to obtain a detailed view of that person's opinions, interests, background, and position, such that this information can be used to determine whether the person is a promising target that should be considered a target or a sales lead to be pursued. A target corresponds to a person who may take a favorable action (e.g., a purchasing decision) in the medium term, for example in the next 1-2 months. By sales lead, it is intended that this refer to an individual (or, more accurately, their avatar) that looks highly likely to take a favorable action (e.g., a purchasing action) in the near future, typically within about a week.

In addition to websites 14-20, the avatar-based automated lead scoring system 100 can be configured to integrate with a direct contact system, such as is available in a direct-contact, cold-calling sales model. In such cases, the avatar-based automated lead scoring system 100 can receive data from sales personnel, for example directly entered at the avatar-based automated lead scoring system 100 or otherwise received from a vendor who wishes to track potential customers (e.g., from vendor site 14, or some other computing system at the vendor that is configured to interface with and provide data to the avatar-based automated lead scoring system 100. Accordingly, in addition to websites 14-20, it is noted that the avatar-based automated lead scoring system 100 can obtain information about the people 12a-n in other ways. For example, avatar information can be obtained from a variety of data sources, such as websites or the person themselves (e.g., via a telephone conversation).

In the embodiment shown, the avatar-based automated lead scoring system 100 is communicatively associated with an avatar database 150, which receives and stores the information collected by the avatar-based automated lead scoring system 100. The avatar database 150 is used, in such embodiments, by the avatar-based automated lead scoring system 100 to assess the various collected avatars, for scoring of the quality of that avatar and its properties relative to one or more known profiles of “good” and “bad” leads, thereby providing automated qualitative assessment of such avatars to predict activity of individuals represented by those avatars, and optionally to suggest actions to be taken with respect to those avatars.

In some embodiments, the avatar database 150 is maintained within the same computing system as implements the avatar-based automated lead scoring system 100. In alternative embodiments, the avatar database 150 is maintained on a separate system, such as a cloud-based data service provider. Still other embodiments involve use of distributed computing networks for both the avatar-based automated lead scoring system 100 and the avatar database 150.

It is noted that, when using the avatar-based automated lead scoring system 100, a person 12a-n may refer to himself or herself differently at different websites. For example, a person may use his or her name on a social networking site such as Facebook, but may use a login name to comment on a public website, or may use a particular “handle” on other websites, such as Twitter or bulletin board systems. Accordingly, it is possible that the avatar-based automated lead scoring system 100 will generate multiple avatars for the same person. Accordingly, to the extent that a user provides information that associates their identities (e.g., by publicizing an association between a name and login name, or name and handle, etc.), multiple avatars could be linked by the avatar-based automated lead scoring system 100, leading to a more accurate and complete picture of the individual. Such collection of avatars is referred to herein as a projected person.

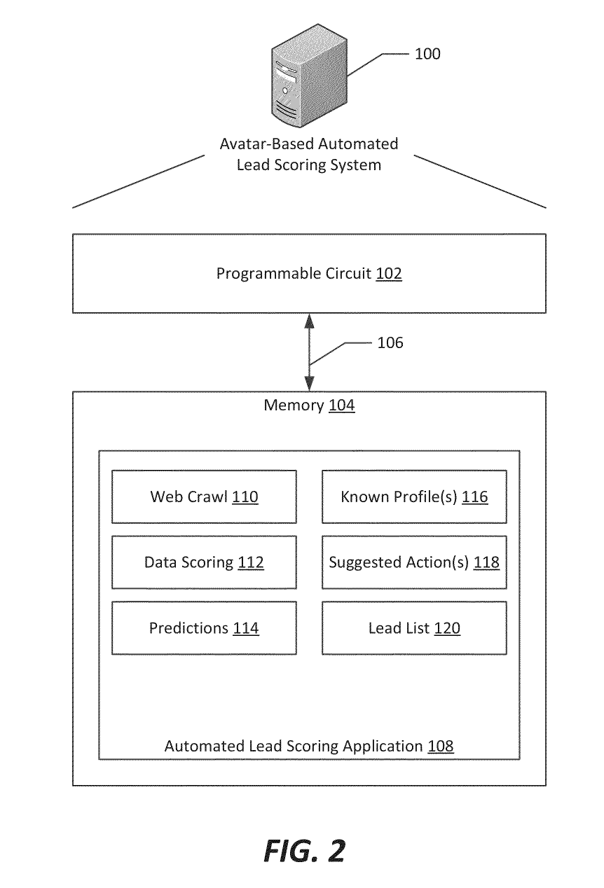

Referring now to FIG. 2, an example of an avatar-based automated lead scoring system 100 is shown, according to an example embodiment. In general, the avatar-based automated lead scoring system 100 includes a processor 102 communicatively connected to a memory 104 via a data bus 106. The processor 102 can be any of a variety of types of programmable circuits capable of executing computer-readable instructions to perform various tasks, such as mathematical and communication tasks.

The memory 104 can include any of a variety of memory devices, such as using various types of computer-readable or computer storage media. A computer storage medium or computer-readable medium may be any medium that can contain or store the program for use by or in connection with the instruction execution system, apparatus, or device. In the embodiment shown, the memory 104 stores an automated lead scoring application 108. The automated lead scoring application 108 includes a plurality of processing components (also referred to as modules, operations, or routines) and data collections, including a web crawl component 110, a data scoring component 112, a predictions component 114, one or more known profiles 116, one or more suggested actions 118, and a lead list 120.

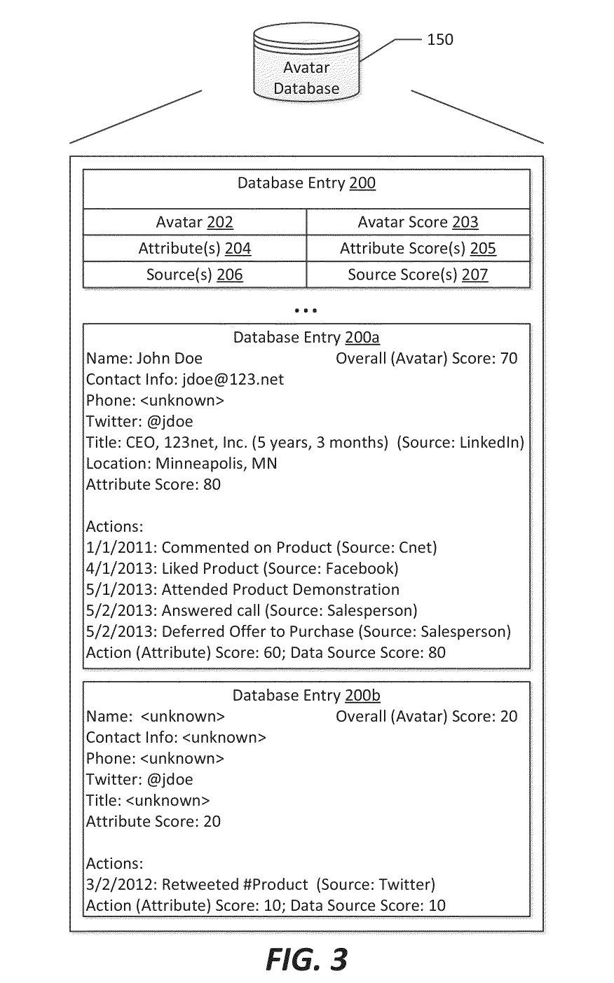

The web crawl component 110 crawls one or more websites, such as websites 14-20 of FIG. 1, to collect any information referencing a particular vendor seeking to qualitatively assess individuals as potential leads. The web crawl component 110 generally is configured to crawl typical websites that are expected to contain information directed to a particular product or service, such as product review websites, the vendor's website, social networking websites, or other sites as noted above. The web crawl component cooperates with the avatar database 150 shown in FIGS. 1 and 3 to store information about new and existing avatars, which can then be acted on by the data scoring component 112 and predictions component 114.

The data scoring component 112 is configured to assess the stored avatars and associated information contained in data records in the avatar database 150, and generate one or more scores used to qualitatively assess various characteristics of the avatar. In example embodiments, the data scoring component 112 can generate a score associated with the avatar overall, as well as a qualitative score relating to each attribute or source of data that is included within the avatar record. For example, various types of contact information may be associated with different qualitative scores; a Twitter handle may have a different qualitative score than an email address, which may have a different qualitative score than an email address or telephone number. In particular, for purposes of lead assessment, the data scoring component 112 can score an overall collection of avatars, each avatar, or each aspect of an avatar. Accordingly, avatars, or data associated with avatars, can be compared and merged or rejected based on likely reliability of that data and the source from which the data is received.

The scores generated by data scoring component 112 can take many forms. In an example embodiment, a 0-100 scale can be used, representing a percentage confidence in the quality of each piece of information associated with an avatar. In some cases, using such a scale, a value outside the range, such as a negative number, could be used to identify that no score has yet been applied to the avatar, attribute, or data source.

It is noted that the various types of scores generated by the data scoring component 112 can be based at least in part on a quality of the data source, as well as the quality of the data itself. For example, information included in a LinkedIn profile, since it is entered by an individual him/herself, would have a relatively high score, while information assigned to an individual, such as a location derived from an IP address of a blog poster, or information provided by a third party, would have a relatively lower accuracy, and an associated lower score. Furthermore, an email address would have a higher score than a Twitter handle or commenter username. It is noted that, since each data source can be scored accordingly, as well as each attribute of an avatar, the overall avatar score would also represent an extrapolation of the amount of data about a particular avatar, as well as the assessed accuracy of that data based on the quality of the data and the quality of the source of that data.

In addition, in some embodiments, the scores can be adjusted based on timeliness of such scores. For example, recently collected information about preferences or location associated with a particular avatar may become stale over time. Different types of data may become stale at different rates; accordingly the data scoring component 112 includes a predefined set of thresholds and degradation rates at which a score may decline, based on stale or unrefreshed data. It is noted that, in many embodiments, the data scoring component 112 can operate substantially continuously, and as such could continuously be adjusted as new information associated with an avatar becomes available, and as previously-collected information degrades over time.

It is noted that, based on the web crawl component 110, one or more avatars may be created for a given individual in the avatar database 150. Such avatars may be based on information entered by the individual, or information that is otherwise publicly available about that individual, such as is available in public records websites. Accordingly, in some embodiments, data scoring component 112 or web crawl component 110 attempts to link avatars by way of shared information (e.g., shared address, name, username, email address, or other information) that is useable to uniquely identify the individual. In particular, an email address or other information not shared by two individuals provides a strong link between avatars associated with the same individual.

The predictions component 114 generates one or more predictions based on the scores of each avatar, and in particular at least the overall score of the avatar and optionally scores of various avatar attributes. This can be done by comparing the avatar scores and attributes to one or more known profiles 116. The known profiles 116 correspond to a collection of profiles of individuals (e.g. resolved avatars) that have a known outcome, such as a sale, a qualified sales lead, a failed lead, or other types of outcomes. For example, a particular known profile (e.g., having an employment attribute of “CEO”) may have a high score associated therewith, since that individual has a high likelihood of affecting purchasing decisions of an entity.

The known profiles 116 can vary depending upon the particular product or service of interest. For example, a known “good” profile of a lead or target for a software security program would not necessarily be a good profile of a lead or target for personal financial services, or other goods or services (e.g., technical consulting assistance). Furthermore, scores may be affected by a size of a company or an amount of time that an individual has spent at a company. For example, a finance buyer is not likely to buy back up software if they work at a large company, but if they work for a small company they are more likely to make that purchasing decision. Accordingly, each industry, company, or company type (e.g., having a similar size and operating in a similar industry) may have a set of known profiles 116, which can include known good, bad, and unknown profiles, which can be used to categorize scored avatars.

In general, the predictions component 114 can generate better predictions for avatars having higher scores, indicating higher-quality data, data indicative of a higher likelihood of action with respect to purchase of a good or service, and more data associated with a particular individual. Such avatars also would have a high likelihood of matching to a known profile, since each would have a relatively large amount of reliable data associated with an individual. At an equivalent score of about 80% most decisions are expected to be easily made, at 40% most decisions should be made. Additionally, where multiple avatars are associated with a particular individual, avatars having higher scores may be compared to avatars having lower scores, for example to detect lower-scored avatars as potentially representing fraudulent or impersonated users.

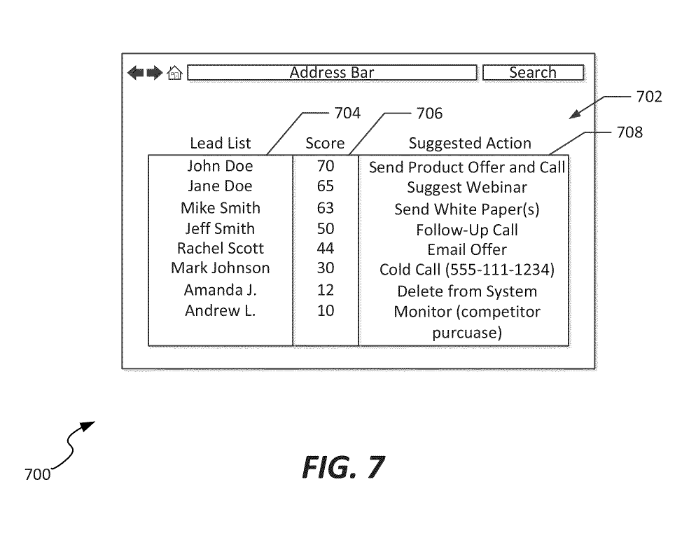

The suggested actions 118 includes a library of possible actions to be taken by a salesperson in response to an avatar, or projected person (i.e., one or more avatars) reaching a particular threshold or sufficiently corresponding to one of the known profiles 116. For example, a suggested action may include direct contact of the individual associated with the avatar, based on historical success associated with such direct contact of other individuals having similar characteristics represented in the known profiles. A further suggested action could be to invite the individual to a training or seminar to further develop that individual into a sales lead, for example based on an expressed interest of that individual in a particular topic (as identified in the avatar). In still further examples, an action could include removing the individual from the avatar database 150, for example based on the individual's scores matching those of known profiles that are historically not successfully converted to sales leads, or flagging an avatar as being either likely unsuccessful, or a possible fraudulent or impersonated user. Other possible actions could be defined as well, some of which are depicted in FIG. 7, below.

The lead list 120 defines a tracking arrangement for a plurality of avatars or projected persons, and can be used to categorize individuals based on their correspondence to known profiles 116. These categories can include sales leads, targets, or cold leads, such as individuals who showed interest in purchasing a good or service some time ago, or who have indicated that they purchased a competing good or service instead. In example embodiments, the lead list 120 can include a plurality of different types of leads, and can be embodied as either separate lists or as a combined list of a variety of types of leads based on scored avatars.

Referring now to FIG. 3, additional details regarding the avatar database 150 are illustrated, in an example embodiment of the present disclosure. As illustrated, the avatar database 150 is configured to interface with the avatar-based automated lead scoring system 100, for example to allow the various components of automated lead scoring application 108 to access avatar records in the avatar database 150. In the embodiment shown, the avatar database specifically includes a plurality of avatar records 200, which each include an avatar identity 202, one or more avatar attributes 204, and data sources 206 associated with the identity and/or attributes. The avatar identity 202 corresponds to a best known identity for the avatar that associates the avatar with an individual, and can include, for example, a name of an individual associated with an avatar. The avatar attributes 204 can include, for example, various descriptive information about a potential customer, such as his/her name, contact information (e.g., email, phone, usernames, etc.), occurrences in which the user was offered and/or purchased similar products or spoke with a salesman, or otherwise was contacted about or commented on a product or service, or a similar product or service.

In the embodiment shown, each avatar record 200 includes a separate score for each avatar identity 202, attribute 204, and data source 206, shown as scores 203, 205, and 207, respectively. These scores can be accessed, updated, and/or modified by the automated lead scoring application 108 over time, and based on collection of additional information regarding that particular avatar, as discussed above, by the data scoring component 112.

In the example shown, and as discussed briefly above, database entries, corresponding to avatar records 200a-b, can include multiple avatar records associated with the same individual. In the embodiment shown, avatar records 200a-b each relate to an individual named “John Doe”, but while avatar record 200a is based on receipt of information from LinkedIn, Facebook, direct contacts, and third party website contacts, avatar records 200b is limited to information gathered from a Twitter account. Accordingly, avatar records 200a includes a variety of types of information from reliable sources (e.g., name, contact information, title, duration in role, location, and a record of actions taken by the avatar), including reliable contact information in the form of email address and name information, avatar record 200b represents an individual utilizing a single data source, and only includes a Twitter identifier, rather than any name, contact information (email, phone, etc.). In both cases, however, the avatar itself is associated with a score, as are various attributes and data sources. As illustrated, an avatar record 200a includes additional information, and can be compared more accurately to a known profile, and accordingly has a higher overall avatar score than avatar records 200b.

It is noted that, in connection with the systems and methods of the present disclosure, in some embodiments scoring reliability of avatar records can be improved by way of maintaining current, accurate data in the avatar database 150. This can include, for example, phasing out old information from avatars, such as reducing a score associated with older activity in an avatar record gradually until the score of that avatar is below a predetermined threshold, at which time the avatar is deleted, or otherwise deleting avatars lacking sufficient information to be assigned a score above a predetermined threshold. Alternatively, one or more manual tools can be incorporated into the overall system, allowing for periodic, manual removal and maintenance of avatar records 200 in the avatar database 150.

As illustrated in FIG. 3, scores associated with an avatar, attribute, or data source can be associated with those aspects of the avatar records 200a-b in different ways. In the examples illustrated in FIG. 3, scores are associated with a group of attributes, such as contact information and/or actions taken by the user. In alternative embodiments, scores can be associated with each attribute individually, and other scores can be associated with collections of attributes. Furthermore, each data source can be individually scored as well, and typically will be individually scored (although such scores may or may not be present or adjustable).

In optional embodiments, the avatar database 150 is further configured such that, in some embodiments, an avatar record 200 can be edited to define an outcome with respect to a particular avatar. For example, a specific avatar could be edited to indicate that a sale was successfully made to the individual represented by that avatar, or that the avatar is associated with an individual who opted to purchase a product from a competitor. In such embodiments, the avatar database 150 can be used to inform the known profiles 116 of FIG. 2. Accordingly, as additional avatars are collected by the avatar-based automated lead scoring system 100, more known profiles will be developed, and the accuracy of the known profile matching process performed by the predictions component 114 can be improved.

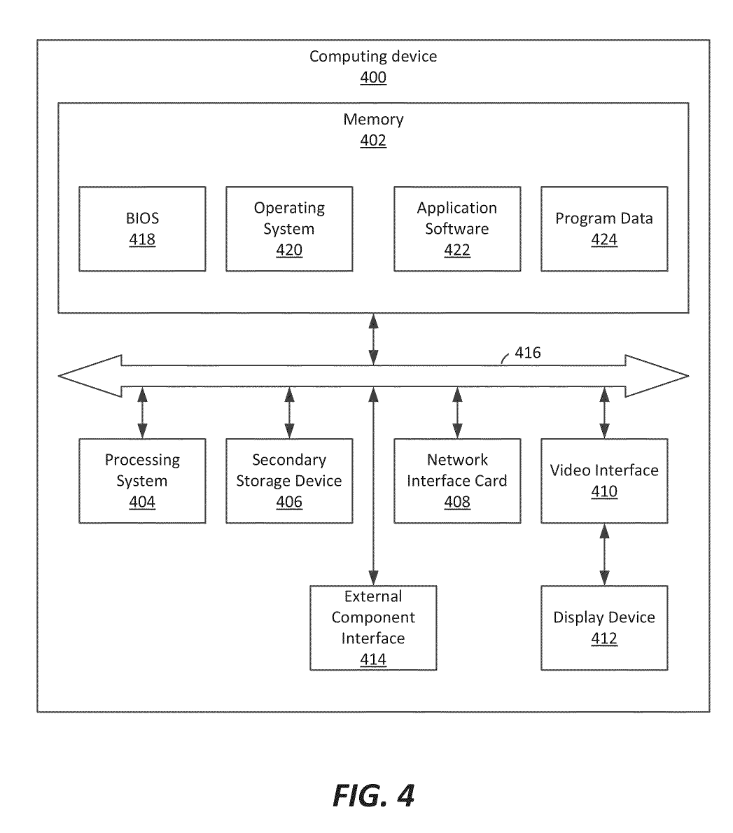

Referring now to FIG. 4, a schematic illustration of an example general-purpose computing device in which aspects of the present disclosure can be implemented. The computing device 400 can represent, for example, a computing system within which aspects of the avatar-based automated lead scoring system 100 could be implemented. It is recognized that, in some embodiments, one or more such computing systems, implemented as server computing systems or as a distributed network of computing systems may also be used to implement aspects of the avatar-based automated lead scoring system 100. Accordingly, the following discussion is intended as exemplary of one such computing system, although it is understood that combinations of computing systems of different types could be used.

In the example of FIG. 4, the computing device 400 includes a memory 402, a processing system 404, a secondary storage device 406, a network interface card 408, a video interface 410, a display unit 412, an external component interface 414, and a communications medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more physical or logical processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as an LCD display panel, a plasma screen display panel, a touch-sensitive display panel, an LED screen, a cathode-ray tube display, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within a computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. By way of contrast, computer storage media includes a tangible (non-transitory) medium or device.

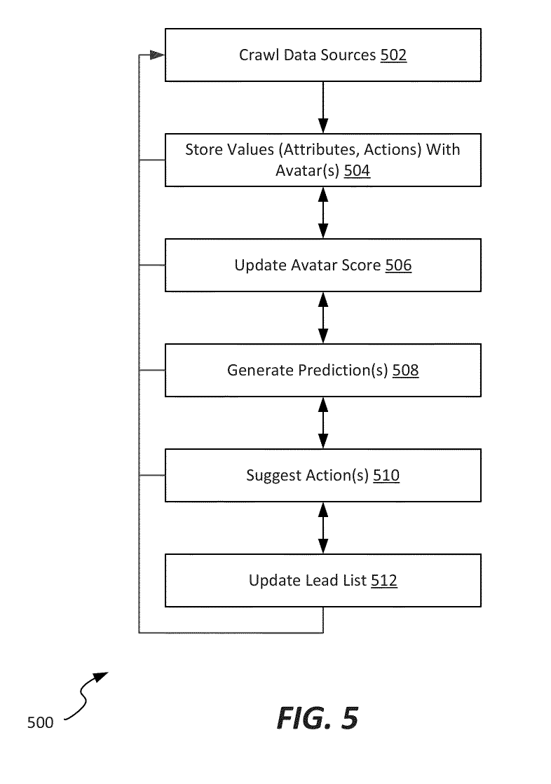

Referring to FIGS. 5-7 methods and an example user interface useable to implement an automated, avatar-based scoring of leads in a computer-based system are described. Example methods described herein can be performed using the avatar-based automated lead scoring system 100 of FIGS. 1-4, such as using the automated lead scoring application 108 of FIG. 2, and example types of automated scoring processes are also discussed. Such examples are provided by way of illustration only, and are not intended as limiting on the scope of the present application

In one example embodiment shown in FIG. 5, a method 500 of scoring sales leads in a computer-based system is disclosed. The method 500 includes a crawl operation 502 that crawls one or more data sources for information regarding one or more avatars. The one or more avatars can be identified based on the crawl of the data sources itself (e.g., by detecting a contact or expressed interest from the avatar to a vendor of interest during the crawl), or could be pre-programmed into the avatar-based automated lead scoring system 100. For example, using the example illustrated in avatar records 200a-b of FIG. 3, John Doe is a real person, with an identity and history with other people. That identity is reflected as one or more avatars based on John Doe's online presence. These avatars may be generated from a social profile, places John Doe has lived, places he has worked, job titles, tenure, and other contact information. Some of this information is better than others, since some avatar information is only available from an unreliable source. However, for purposes of the crawl operation 502, all such information is collected.

The method 500 further includes a storage operation 504, in which the avatar-based automated lead scoring system 100 stores the crawled information in a database associated with each avatar of interest. This can occur, for example, in an avatar database 150.

A scoring update operation 506 operates continuously, periodically updating a score associated with the avatar by compiling a score based on the overall avatar, including any newly-collected information retrieved during the crawl operation 502, as well as gradually degrading (e.g., lowering the score associated with or deleting) of old data as it becomes stale. As noted above, the scoring update operation 506 can update an overall score associated with an avatar (e.g., score 203 of FIG. 3), or can update each score associated with each avatar, attribute of an avatar, and data source from which each avatar and/or attribute is obtained.

A predictions operation 508 generates or updates one or more predictions associated with each avatar. The predictions can take any of a number of forms. For example, predictions can identify a likelihood that a particular avatar is associated with a person who is likely to purchase a good or service of a particular type. That avatar can be compared against one or more known profiles to determine whether the avatar is a good match as a target, sales lead, or other individual who should be added to a lead list associated with a particular vendor. The predictions operation 508 uses the scores generated by the scoring update operation 506 to generate continuous predictions associated with each avatar, thereby continuously, and automatically, assessing each avatar.

By way of example, the predictions operation can compare the John Doe profile to a corresponding profile of other customers. In such cases, former CEOs are targeted for providing training services. In some cases, a past good customer had a propensity to attend a free online training seminar, and was typically a C-Suite (e.g., CEO) executive for at least about 10 years at a small company. Such customers could also be characterized in that they lost a job in the last six months, and as such may be in search of such training, which could be offered as a service to the user. If an update to a social profile of the John Doe avatar indicates a change in job title, that change may be scored and may best match a profile of a customer, and as such may trigger a suggested action.

In contrast, the same John Doe profile may be compared to a “bad” profile, corresponding to an individual who is unlikely to purchase an offered good or service. For example, an active CEO at a large company who typically participates in weekend trainings, but does not always complete them, may not typically purchase the same product or service as the former CEO in the example above. Since the John Doe profile more closely matches the “good” profile, a match is provided.

It is noted that, in some cases, avatars will not provide a good match for a prediction to be made. For example, in the case a person has multiple, very different avatars, that individual could be assumed to be using incorrect data for at least some of those avatars (e.g., using a false name in a Facebook or Twitter profile, etc.) In such cases, the person would be scored lower based on the lack of correspondence, which could, in some cases, lead to the person being culled from the system and subsequently ignored. Other avatars that would be ignored would be those that have not been updated in a substantial amount of time (e.g., years), and therefore represent unreliable data. To the contrary, other avatars represent good matches. For example, an avatar may be associated with a person who has recently purchased goods/services from the vendor of interest; such an action results in a high positive score, due to the likelihood of a repeat customer.

In some cases, avatars that do not provide a good match, or otherwise provide limited information about a person's identity or propensity to purchase goods or services can also be used in other contexts. For example, comparison of a first avatar associated a person and having a high degree of detail can be compared to a second avatar associated with the same person but having a low degree of detail. The second avatar might include information inconsistent with the first avatar, and, in such cases, the second avatar may be flagged as being fake or incorrect. Identifying such avatars can provide a way of avoiding a “catfishing” online scam, or other types of fraudulent transactions in which such an avatar is used to impersonate another person.

The suggested actions operation 510 generates one or more suggested actions, for example based on the predictions generated by the predictions operation. These suggested actions can also take a variety of forms, and can be isolated to a particular avatar, or can coordinate among a variety of avatars. For example, in some embodiments, the suggested actions operation 510 generates an indication of who should be contacted by salespeople next, due to having a high score and matching a known profile for which direct contact has been successful. The suggested actions operation 510 can include a suggestion as to a likely amount that the person represented by the avatar can pay for a given product or service (e.g., based on the occupation or position included in the avatar), as well as when and in what quantity that person might purchase goods/services. The suggested actions operation 510 can also determine whether one or more individuals represented by avatars should receive a courtesy email, or other type of communication to keep that contact “warm”. These can be, for example, individuals who have accessed a support log on a vendor site (e.g., vendor site 14 of FIG. 1) to obtain information about a product; such individuals may be receptive to direct contact, for purposes of providing services to that individual if a current client, or contact to initiate a purchase of a product that is associated with the access.

Again, continuing the John Doe example, the suggested actions operation 510 would determine, based on the fit to a “good” profile in the predictions operation 508, the suggested actions operation 510 recommends that a special offer be made to John Doe via an email address, which includes incentives for a further training; if the incentives are redeemed, John Doe can be moved to a buyer portion of the lead list; if the incentives are not redeemed, he will remain a target that requires further nurturing/contact.

In addition, a lead list update operation 512 can use the scoring update operation 506 and predictions operation 508, which determine whether to update a lead list, to in fact maintain and update a lead list. the lead list update operation 512 can, in some embodiments, be automated based on the predictions operation 508, or can be an at least partially manual process that can be performed by a vendor who wishes to amend his/her lead list based on suggested actions to update a lead list, again based on the assessments of scores relative to known profiles in the predictions operation 508.

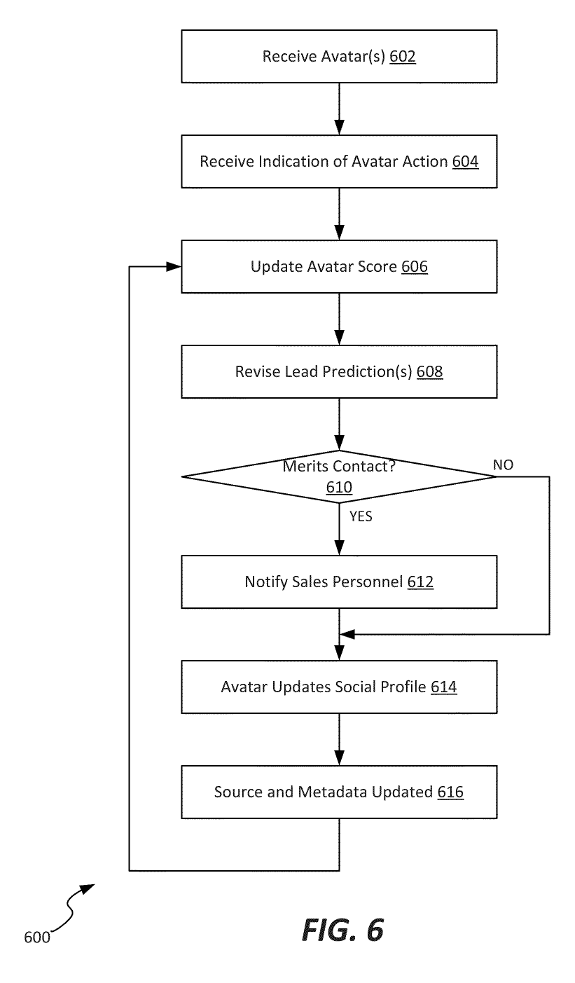

Referring now to FIG. 6, a further example method 600 of scoring sales leads in a computer-based system is illustrated. The method 600 can, in some embodiments, represent an example flow using the avatar-based automated lead scoring system 100, and represents a particular sequence of operations through the method 500 of FIG. 5, above.

In the embodiment shown, the method 600 includes an avatar receipt operation 602, which receives avatars into an avatar database 150 and generates records associated with each avatar. In various embodiments, the avatar is stored in the avatar database from a third party source, such as a user list received from a vendor seeking to automatically assess leads. Each avatar is stored and scored with a default value (e.g., a score of 0) representing that little is known about that avatar or the underlying user. If the avatar is already in the avatar database 150, that avatar would receive a further attribute indicating that it is part of a specific user list; such an attribute would also have little value, and would be scored accordingly. Additionally the source (e.g., user list) would be added to each avatar as well, with a baseline score, in particular when the quality of that source may not be known.

The method 600 further receives an indication of user action, via user action operation 604. The user action can be retrieved, for example, based on crawl operation 502 of FIG. 5; however, regardless of how such action occurs, it is used to update an avatar score at scoring update operation 506. For example, an avatar may take an action such as liking an article describing a vendor; as such, the avatar record would receive a “like” attribute, and the avatar score would be increased. Additionally, an avatar may click on an advertisement, which would also result in updating of an avatar record and increasing the avatar score (although typically by a different amount than a “like”). Furthermore, the avatar may register for a product trial, which results in a further update to the avatar records and a much higher score increase (since a product trial represents a higher likelihood of ultimate purchase of a product or service). The avatar may also call a salesperson, which is a further attribute and would be associated with a further score increase.

In addition to the above example, avatars may take a variety of other actions that provide further information that can be used to predict whether the user associated with that avatar will ultimately purchase a product or service. For example, the avatars may attend webinars, talk to technical support, review weblogs and/or information pages describing products or services. Each such action can be stored in an avatar record, and can be used to update an avatar score. Similarly, lack of activity provides a strong negative prediction that can have a negative effect on a score of an avatar. Furthermore, activity inconsistent with prior activity patterns, or providing information inconsistent with previously-provided information, may lead to a prediction that an avatar represents an unreliable predictor (e.g., may be fraudulent or unreliable).

Continuing to refer to FIG. 6, after avatar scores are updated, a prediction update operation 608 updates or revises the prediction associated with an avatar. This can include, for example, downgrading a lead to a target based on the lead's inactivity, or upgrading a particular avatar based on subsequent actions. It is noted that, since avatars are consistently taking various actions, scores and associated predictions will continuously be revised.

A contact assessment operation 610 determines, based on particular attributes of an avatar, whether the avatar merits direct contact. This may be due to the avatar being upgraded on a lead list to a lead having a high likelihood of purchase. This may be in response to viewing a number of product reviews in quick succession followed by a request for a demonstration of a product, which indicates a high likelihood to purchase. If contact is merited, a notification operation 612 notifies sales personnel. If no contact is merited, or after the sales personnel is notified, the avatar may update his or her social profile in operation 614, which results in updating of source and metadata information at operation 616.

Referring to FIGS. 5-6 generally, it is noted that these processes are performed both with respect to leads and current customers; as such, avatars are tracked throughout a customer's life cycle within the avatar-based automated lead scoring system 100. After a person makes a purchase, that person's score will increase, and allows for validation of other avatars by optionally being used as a known profile (as discussed above). Such learnings can also be used to adjust a scoring algorithm; for example, if LinkedIn contact information proves over time to be highly reliable, the existence of such contact information as an attribute of an avatar may have higher weight relating to its accuracy. Alternatively, unknown business addresses could be ranked relatively lower.

FIG. 7 illustrates a schematic user interface 700 with which a salesperson can interact with an avatar-based automated lead scoring system, according to an example embodiment. The user interface 700 illustrates an example guide to a salesperson that allows that salesperson to view automatically assessed avatars, and follow automatically-generated recommendations regarding actions to take relative to such avatars.

In the embodiment shown, the user interface 700 displays a task list 702 that includes a lead list 704, associated scores 706, and further suggested actions 708. The task list prioritizes users in order of score, from most likely to purchase a product or service to least likely to purchase that product or service. This may be based on ascending scores in the scores 706, or may be based on particular characteristics of an avatar that strongly predicts purchase of a good/service. The suggested actions can include, for example a variety of actions based on the strength of the avatar. For example a strong avatar, or lead, could be associated with a suggestion to send to the avatar a product offer or call. Lower scored avatars may have associated suggested actions that would correspond to nurturing the contact, for example with follow-up calls, email offers, or other correspondence. Still other avatars, for example those who have provided some indication that a competing product was purchased, can also be assessed. For example, if this information was gathered during a cold call or other contact, the salesperson is typically in contact with the person, and would be able to validate as much data as possible for that user, to determine what about that user would indicate his/her propensity to purchase the competing product. This information can be used in a known “bad” profile, as discussed above.

Although the user interface 700 depicts one possible method by which suggested actions are communicated to sales personnel, it is recognized that other options are available as well. For example, rather than a web-based user interface, an email system could be integrated with the overall system, and could apportion actions out among multiple sales personnel. Still other examples could be implemented as well (e.g., based on a desktop application, mobile application, etc.)

Referring to FIGS. 1-7 generally, it is noted that the avatar-based automated lead scoring system 100 provides numerous advantages over traditional cold calling and marketing processes. For example, the system is largely automated, and provides for continued learning improvement with respect to likely purchasers based on continued gathering of additional information relating to avatars that are and are not customers. Such automation and continued improvement leads to substantial cost and time savings for sales and marketing personnel to identify the most efficient contacts or other efforts possible to develop sales and contacts. Still other advantages are realized by the methods and systems discussed herein, and are reflected above in the present description.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. An automated lead scoring system comprising:
a web crawling process executing on a computing system, the web crawling process configured to collect data from one or more disparate, unaffiliated data sources to obtain information describing attributes of an avatar, the attributes including information descriptive of a prospective customer and actions taken by the prospective customer in response to exposure to a product or service;
a database communicatively connected to the computing system and configured to receive the information for storage in a database entry associated with the avatar;
a scoring component assigning a value in the database entry to each of an avatar, attributes of the avatar, and each data source from which the attributes are retrieved;
a prediction component configured to compare based on a correspondence between the database entry and known profiles of users of a product or service.

2. The automated lead scoring system of claim 1, wherein the data sources include unaffiliated, publically accessible websites.

3. The automated lead scoring system of claim 1, wherein the data sources include social media websites.

4. The automated lead scoring system of claim 1, further comprising an action component configured to generate a suggestion of one or more actions to take relative to the avatar, the one or more actions including making an offer to the avatar.

5. The automated lead scoring system of claim 1, further comprising a lead list including sales leads from among a plurality of avatars tracked in the database.

6. The automated lead scoring system of claim 1, wherein the known profiles further include known profiles of non-users of the product or service.

7. A method of scoring sales leads in a computer-based system, the method comprising:
periodically performing an automatic crawling process across one or more disparate, unaffiliated data sources to obtain information describing attributes of an avatar, the attributes including information descriptive of a prospective customer and actions taken by the prospective customer in response to exposure to a product or service;
storing values associated with the avatar, the attributes of the avatar, and the source from which information is received in a database record;
continuously tracking a score for the avatar based on aggregated values; and
generating one or more predictions based on a correspondence between the database record and known users of a product or service.

8. The method of claim 7, wherein the one or more predictions are based at least in part on the score for the avatar.

9. The method of claim 7, further comprising, in the absence of a corresponding database record for the avatar, creating a database record associated with the avatar.

10. The method of claim 7, further comprising storing the information in the database record, the information further describing a time at which each of the one or more actions was taken by the avatar.

11. The method of claim 7, wherein at least some of the one or more actions taken by the lead are associated with point values, and wherein storing values corresponding to the avatar includes adjusting an existing score in the database record by aggregating the point values to arrive at an overall score for the avatar.

12. The method of claim 11, further comprising, prior to generating one or more predictions, adjusting a score associated with the avatar in the database record based at least in part on elapsed time since actions reflected in the overall score have occurred.

13. The method of claim 7, wherein the one or more actions are selected from a group of actions consisting of:
commenting on the product or service;
selecting an advertisement of the product or service;
liking an article associated with the product or service;
attending a web presentation;
visiting a webpage describing the product or service; and
reviewing the product or service.

15. The method of claim 7, wherein the one or more actions includes inaction, and wherein, in response to the inaction, a score of the avatar is reduced.

16. The method of claim 7, wherein the values to be stored in the database record are selected based at least in part on a data source from which the associated one or more actions taken by the avatar was received.

16. The method of claim 7, further comprising compiling a projected person based on a plurality of avatars.

17. The method of claim 16, wherein the one or more predictions include an estimate based on database records associated with the plurality of avatars of one or more actions likely taken by the prospective customer.

18. The method of claim 17, further comprising, based on the one or more predictions generating a suggestion of one or more actions to take relative to the prospective customer.

19. The method of claim 18, wherein the suggestion defines an offer to be made to the prospective customer based on a similarity between a known customer and the projected person corresponding to the prospective customer.

20. The method of claim 7, wherein a plurality of avatars are associated with a user, and wherein generating one or more predictions further includes:
comparing a first avatar of the plurality of avatars with a second avatar of the plurality of avatars, the second avatar having a lower degree of detail as compared to the first avatar;
upon detecting inconsistent information between the first avatar and the second avatar, flagging the second avatar as containing incorrect information.

21. The method of claim 20, wherein the first avatar is the known user.

22. A computer-readable storage medium comprising computer-executable instructions which, when executed, cause a computing system to perform a method of scoring sales leads in a computer-based system, the method comprising:
periodically performing an automatic scraping process across one or more disparate, unaffiliated data sources to obtain information describing attributes of an avatar, the attributes including information descriptive of a prospective customer and actions taken by the prospective customer in response to exposure to a product or service;
storing values associated with the avatar, the attributes of the avatar, and the source from which information is received in a database record;
continuously tracking a score for the avatar based on aggregated values, the score based at least in part on elapsed time since actions reflected in the overall score have occurred;
generating one or more predictions based on a correspondence between the database record and known users of a product or service to estimate one or more actions likely taken by the avatar; and
generating a suggestion of one or more actions to take relative to the avatar, the one or more actions including making an offer to the avatar;
based on a response to the offer, adjusting the score for the avatar.
